(19) United States
(12) Patent Application Publication
(10) Pub. No.: US 2008/0186152 A1
(43) Pub. Date: Aug. 7, 2008

(54) HAPTIC EXPERIENCE SERVICE METHOD AND SYSTEM

(75) Inventors: Ki Uk Kyung, Daejeon (KR); Yong Hee Lee, Daejeon (KR); Jun Seok Park, Daejeon (KR); Dong Won Han, Daejeon (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Electronics & Telecommunications Research Institute, Daejeon (KR)

(21) Appl. No.: 11/966,623

(22) Filed: Dec. 28, 2007

(30) Foreign Application Priority Data
Feb. 2, 2007 (KR) 10-2007-0010921

(51) Int. Cl. H04B 3/36

(52) U.S. Cl. 340/407.1

(57) ABSTRACT

A haptic experience service method and system are provided. The haptic experience service system, includes: a haptic reproduction apparatus providing haptic information of a force and texture of a virtual object or environment to a user; a server defining a virtual environmental factor corresponding to a user-desired haptic experience service by using a haptic contents database constructed with an environmental factor definition package, generating an experience environment corresponding to the environmental factor, and generating a haptic data output value corresponding to an input data of the haptic reproduction apparatus in the experience environment by using an interaction value definition package and an apparatus definition variable of the haptic reproduction apparatus; and a client recognizing an access of the haptic reproduction apparatus, providing the apparatus definition variable of the haptic reproduction apparatus to the server by using an apparatus definition data package, displaying a visual data associated with the experience environment generated by the server, transmitting to the server an input data generated by a user's manipulation and received from the haptic reproduction apparatus, receiving the haptic data output value interacted with the input data, and providing the haptic data output value to the haptic reproduction apparatus.

Accordingly, it is possible to efficiently provide the haptic information to the user.

### CROSS-REFERENCE TO RELATED APPLICATIONS

This application claims the priority of Korean Patent Application No. 10-2007-0010921 filed on Feb. 2, 2007, in the Korean Intellectual Property Office, the disclosure of which is incorporated herein by reference.

### BACKGROUND OF THE INVENTION

1. Field of the Invention

The present invention relates to a haptic experience service method and a haptic experience service system, and more particularly, to a haptic experience service method and a haptic experience service system capable of effectively providing haptic information on force and texture to a user. This work was supported by the IT R&D program of MIC/IITA [2006-S-031-01, Five Senses Information Processing Technology Development for Network Based Reality].

2. Description of the Related Art

Recently, as a multimedia technology has been developed, a technology of integrating information of human sense and providing the information to users has been actively researched.

Particularly, various methods of providing information of a haptic sense (sense of touch) among the human senses have been proposed.

As an example, in U.S. Pat. No. 6,424,333, at least one vibration haptic apparatus and an actuator are used, and a haptic sense is provided to a user through vibration of the vibration haptic apparatus actuated by the actuator. As another example, in U.S. Pat. No. 5,844,392, a geometrical database is browsed by using haptic feedback, so that information of a haptic sense is provided to a user.

In the aforementioned patents, only the vibration feedback or the force feedback is used. Therefore, various haptic experiences cannot be efficiently provided.

In addition, in the Document, “XML-based Representation of Haptic Information” (J. Zhou, et al. HAVE2005), network-based haptic service and a data format therefore are disclosed. A data structure having categories such as General, Haptic Interface, Haptic Rendering, Graphic Rendering API, Metadata, and Rights are simply proposed. However, a method of providing a haptic experience service consistently by using a data package is not disclosed.

### SUMMARY OF THE INVENTION

A first aspect of the present invention is providing a haptic experience service method and system capable of efficiently providing various types of haptic information to a user.

A second aspect of the present invention is providing a haptic experience service method and system capable of uniformly providing haptic experience services to a user irrespective of types of a haptic reproduction apparatus.

According to an aspect of the present invention, there is provided a haptic experience service system, comprising: a haptic reproduction apparatus providing haptic information of a force and texture of a virtual object or environment to a user; a server defining a virtual environmental factor corresponding to a user-desired haptic experience service by using a haptic contents database constructed with an environmental factor definition package, generating an experience environment corresponding to the environmental factor, and generating a haptic data output value corresponding to an input data of a haptic reproduction apparatus in the experience environment by using an interaction value definition package and an apparatus definition variable of the haptic reproduction apparatus; and a client recognizing an access of the haptic reproduction apparatus, providing the apparatus definition variable of the haptic reproduction apparatus to the server by using an apparatus definition data package, displaying a visual data associated with the experience environment generated by the server, transmitting to the server an input data generated by a user's manipulation and received from the haptic reproduction apparatus, receiving the haptic data output value interacted with the input data, and providing the haptic data output value to the haptic reproduction apparatus.

In the above aspect, the client may comprise: an apparatus definition unit including the apparatus definition data package to define variables of type and feature of the haptic reproduction apparatus; an environmental factor definition unit allowing the user to select the virtual environmental factor corresponding to the user-desired haptic experience service; and a controller providing the virtual environmental factor selected through the environmental factor definition unit to the server, displaying the visual data associated with the virtual experience environment provided from the server on a display screen, and transmitting the haptic data output value and the input data generated from the server and the haptic reproduction apparatus to the haptic reproduction apparatus and the server.

In addition, the client may transform a coordinate system and a scale of the haptic data output value and the input data generated from the server and the haptic reproduction apparatus in reflection of a feature of the haptic reproduction apparatus by using a transformation matrix corresponding to the haptic data output value and the input data and transmits the transformed haptic data output value and input data to the haptic reproduction apparatus and the server.

In addition, the server may comprise: the haptic contents database including the environmental factor definition package to define a virtual haptic experience environmental factor to be serviced to the user accessing the server through the client; an experience environment definition unit defining the environmental factor selected by the user and generating the experience environment corresponding to the environmental factor; and an interaction value definition unit including the interaction value definition package to generate the haptic data output value interacted with the input data by using the interaction value definition package when receiving the input data of the haptic reproduction apparatus requested to be applied to the experience environment.

In addition, the server may calculate a correlation between a previously calculated experience environment data and the input data by using the interaction value definition package to generate the haptic data output value.

According to another aspect of the present invention, there is provided a haptic experience service system, comprising: a haptic reproduction apparatus providing haptic information of a force and texture of a virtual object or environment to a user; a server defining a virtual environmental factor to be serviced to the user by using a haptic contents database constructed with an environmental factor definition package; and a client recognizing an access of the haptic reproduction apparatus, generating an experience environment corresponding to the virtual environment factor, displaying a visual data associated with the experience environment, generating a haptic data output value interacted with the input data generated by a user's manipulation and received from the haptic reproduction apparatus by using an interaction value definition package, and providing the haptic data output value to the haptic reproduction apparatus.

In the above aspect, the client may comprise: an apparatus definition unit including the apparatus definition data package to select variables of type and feature of the haptic reproduction apparatus; an environmental factor definition unit selecting the virtual environmental factor corresponding to the user-desired haptic experience service; a controller transmitting the virtual environmental factor selected by the environmental factor definition unit to the server to generate the experience environment corresponding to the virtual environmental factor, extracting a visual data associated with the experience environment to display the visual data, and transmitting to the haptic reproduction apparatus the haptic data output value corresponding to the input data of the haptic reproduction apparatus in cooperation with the apparatus definition unit and the interaction value definition unit; and the interaction value definition unit including the interaction value definition package to define the haptic data output value interacted with the input data provided from the haptic reproduction apparatus.

In addition, the client may calculate a correlation between a previously calculated experience environment data and the input data by using the interaction value definition package to generate the haptic data output value.

In addition, the server may comprise: a haptic contents database including the environmental factor definition package to allow the user accessing the server through the client to select the virtual environmental factor corresponding to the user-desired haptic experience service; and an environmental factor definition unit defining the virtual environmental factor selected by the user to provide the virtual environmental factor to the client.

In addition, each of the packages may have an ID (identifier) unique to the package, wherein each of the packages includes a plurality of classes having the same ID, and wherein each of the classes include a plurality of variables.

In addition, each of the packages may be constructed with at least one of one file, one character string, a set of files, and a set of character strings, in case of the package constructed with a file or files, features of elements are represented by using a markup language or a script, and in case of the package constructed with a character string or character strings, internal elements are represented to be sequentially arranged.

In addition, the apparatus definition data package may include variables for defining a type and physical properties of an apparatus, wherein the environmental factor definition package includes variables for a virtual object, an object-surface feature, and an environment of the object that are used for the haptic experience service, wherein the interaction value definition package includes apparatus input/output data variables and haptic data calculation variables that are used to generate the haptic data output value.

In addition, the apparatus definition data package may include: a force feedback apparatus class including at least one of an apparatus name variable, a degree-of-freedom variable, an operating range variable, a resolution variable, a maximum output force variable, an output torque variable, a maximum output impedance variable, and a sampling frequency variable; and a texture expression apparatus class including at least one of an apparatus name variable, a number-of-stimulus-pins variable, a pin array structure variable, a stimulus pin interval variable, a stimulus pin size variable, a stimulus pin maximum displacement variable, a frequency bandwidth variable, a stimulus pin supporting force variable, a stimulus pin maximum force variable, a maximum thermal conductivity variable, and a vibration output range variable.

In addition, the environmental factor definition package may include: an object class including at least one of a virtual object name variable, a geometrical shape variable, a mass variable, an elastic coefficient variable, a damping coefficient (viscosity coefficient) variable, and a position variable; a surface feature class including at least one of an object-surface groove depth variable, a groove size variable, a grain direction variable, a grain density variable, a roughness variable, a friction variable, a temperature variable, a thermal conductivity variable, a pattern variable, and an interested region coordinate variable; and an environmental condition class including a gravity amplitude variable, a gravitational direction variable, and a flow direction variable and a viscosity variable of a fluid in a space enclosing the object.

In addition, the interaction value definition package may include: an apparatus input/output data class including at least one of a position variable, a velocity variable, an acceleration variable, and a direction variable that are generated in the haptic reproduction apparatus and at least one of an output force variable and an output torque variable that are to be provided to the haptic reproduction apparatus; and a haptic data calculation class including at least one of a haptic reproduction library variable, a collision determination variable, a force calculation value variable, a torque calculation value variable, a stimulus-pin displacement variable, a stimulus-pin force variable, and a stimulus-pin frequency variable.

In addition, the haptic reproduction apparatus may comprise: a force feedback apparatus including a grip for providing a haptic sense of the virtual object or environment to the user, so that a force haptic sense associated with the virtual object and environment is provided to the user through the grip; and a texture expression apparatus including a pin array having a plurality of pins for directly stimulating a skin of the user, so that a texture haptic sense is provided to the user through the pin array. In addition, the texture expression apparatus may further comprise at least one of a vibration motor and a heat transfer device.

According to still another aspect of the present invention, there is provided a haptic experience service method in a haptic experience service system, comprising: a user who desires to receive a haptic experience service selecting and inputting a type and feature of a haptic reproduction apparatus through a client connected to the haptic reproduction apparatus; the client generating an apparatus definition data package based on the type and feature of the haptic reproduction apparatus and transmitting the apparatus definition data package to the server; the user accessing the server through the client and selecting a virtual environmental factor corresponding to a user-desired virtual haptic experience service; the server defining the virtual environmental factor according to the user's selection, generating a virtual experience environment corresponding to the virtual environmental factor, and providing a visual data of the virtual experience environment to the client; the client displaying the visual data on a display screen and transmitting an input data received from the haptic reproduction apparatus to the server under the control of the user who checks the visual data; and the server generating a haptic data output value interacted with the input data and providing the haptic data output value to the haptic reproduction apparatus through the client.

In the above aspect, in the server generating the haptic data output value, the server may calculate a correlation between a previously calculated experience environment data and the input data by using an interaction value definition package including apparatus input/output data variables and haptic data calculation variables to generate the haptic data output value.

In addition, in the client transmitting the input data to the server, the client may transform a coordinate system and a scale of the input data in reflection of the feature of the haptic reproduction apparatus by using a transformation matrix corresponding to the input data and transmit the transformed input data to the server.

In addition, in the client transmitting the haptic data output value to the haptic reproduction apparatus, the client may transform a coordinate system and a scale of the haptic data output value in reflection of the feature of the haptic reproduction apparatus by using a transformation matrix corresponding to the haptic data output value, and transmit the transformed haptic data output value to the server.

According to further still another aspect of the present invention, there is provided a haptic experience service method in a haptic experience service system, comprising: a user who desires to receive a haptic experience service selecting and inputting a type and feature of a haptic reproduction apparatus through a client connected to the haptic reproduction apparatus; the client generating an apparatus definition data package based on the type and feature of the haptic reproduction apparatus and transmitting the apparatus definition data package to the server; the user accessing the server through the client and selecting a virtual environmental factor corresponding to a user-desired virtual haptic experience service, so that the server defines an environmental factor according to the user's selection and provides the environmental factor to the client; the client generating an experience environment corresponding to the environmental factor, extracting a visual data associated with the experience environment, and displaying the visual data on a display screen; and the client generating a haptic data output value interacted with the input data received from the haptic reproduction apparatus under the control of the user and providing the haptic data output value to the haptic reproduction apparatus.

In the above aspect, in the server providing the environmental factor to the client, the server may generate an environmental factor data package and transmit the environmental factor data package to the client.

In addition, in the client generating the haptic data output value, the client may calculate a correlation between a previously calculated experience environment data and the input data by using an interaction value definition package including apparatus input/output data variables and haptic data calculation variable to generate the haptic data output value.

In addition, in the client transmitting the apparatus definition data package to the server, the client may transmit the apparatus definition data package in a format of file or character string to the server.

In addition, in the user selecting the virtual haptic experience environmental factor, the user may access a haptic contents database of the server including variables for a virtual object, an object-surface feature, and an environment of the object that are used for the haptic experience service and selects an environmental factor variable included in the haptic contents database.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view illustrating a configuration of a haptic experience service system according to an embodiment of the present invention;

FIG. 2 is a view illustrating a configuration of a haptic reproduction apparatus of the haptic experience service system according to the embodiment of the present invention;

FIG. 3 is a view illustrating a configuration of a client of the haptic experience service system according to the embodiment of the present invention;

FIG. 4 is a view illustrating a configuration of a client of a haptic experience service system according to another embodiment of the present invention;

FIG. 5 is a view illustrating a configuration of a server of a haptic experience service system according to an embodiment of the present invention;

FIG. 6 is a view illustrating a configuration of a server of a haptic experience service system according to another embodiment of the present invention;

FIG. 7 is a view illustrating a data package structure of a haptic experience service system according to an embodiment of the present invention;

FIG. 8 is a view illustrating a configuration of a force feedback apparatus of a haptic experience service system according to an embodiment of the present invention;

FIG. 9 is a view illustrating a configuration of a texture reproduction apparatus of a haptic experience service system according to an embodiment of the present invention;

FIG. 10 is a signal flowchart illustrating a haptic experience service method according to an embodiment of the present invention;

FIG. 11 is a signal flowchart illustrating a haptic experience service method according to another embodiment of the present invention; and

FIG. 12 is a flowchart illustrating a data package invoking method in a haptic experience service system according to an embodiment of the present invention.

### DETAILED DESCRIPTION OF THE PREFERRED EMBODIMENT

Hereinafter, exemplary embodiments of the present invention will now be described in detail with reference to the accompanying drawings. However, if the detailed description of well-known functions or constructions is determined not to clarify the present invention, the detailed description thereof may be omitted.

In the accompanying drawings, elements having similar functions and operations are denoted by the same reference numerals.

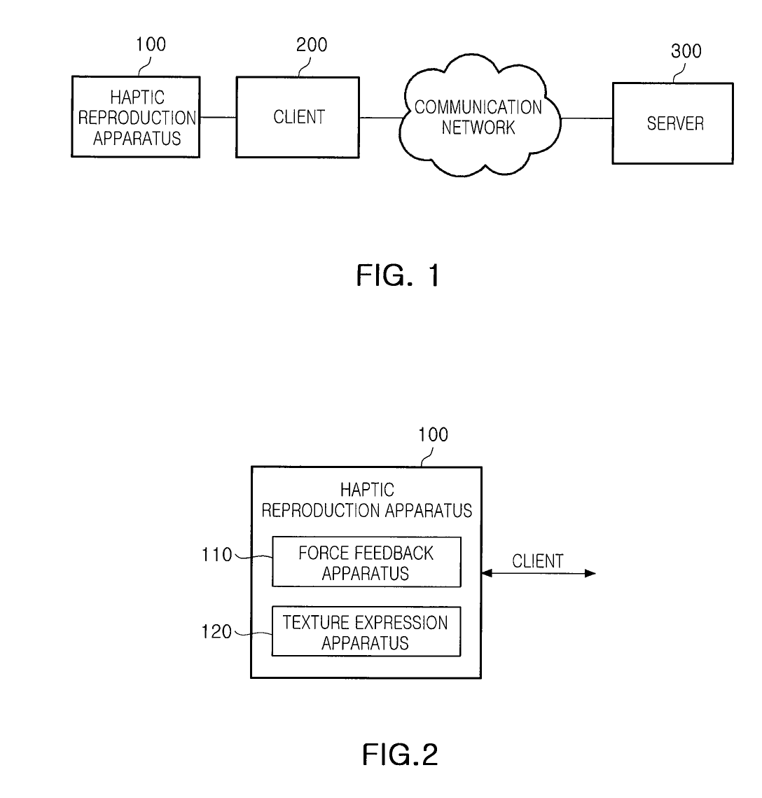

FIG. 1 is a view illustrating a configuration of a haptic experience service system according to an embodiment of the present invention.

As shown in FIG. 1, the haptic experience service system according to the embodiment of the present invention includes a haptic reproduction apparatus 100, a client 200 and a server 300.

The haptic reproduction apparatus 100 has a function of providing haptic information of a virtual object or environment to a user. More specifically, the haptic reproduction apparatus 100 provides force and texture quantitatively calculated by the client 200 and the server 300 as the haptic information of the virtual object or environment to the user.

The client 200 is connected to the server 300 via a communication network to recognize connection of the haptic reproduction apparatus 100 and to allow a user required haptic experience service to be provided from the server 300 to the haptic reproduction apparatus 100.

The client 200 receives a type and feature of the accessed haptic reproduction apparatus 100 from the user. The client 200 generates an apparatus definition data package which defines the type and feature and provides the apparatus definition data package to the server 300, so that a haptic experience service reflecting the type and feature of the haptic reproduction apparatus 100 can be provided from the server 300 to the haptic reproduction apparatus 100.

The server 300 includes a haptic contents database constructed with a plurality of environmental factor variables. The server 300 allows the user to select an experience environmental factor corresponding to the user-desired haptic experience service, that is, a type and feature of virtual object and an environmental condition from the haptic contents database. The server 300 defines a plurality of haptic data calculation variables and apparatus input/output data variable, so that the haptic experience service to which the apparatus definition data provided from the client 200 and the experience environmental factor selected by the user are applied can be generated as a haptic data output value through the variables.

In the haptic experience service system, the type and feature of the haptic reproduction apparatus 100, the virtual experience environmental factor corresponding to the user-desired haptic experience service, and data required for interaction to the virtual object constitutes a package, and the package can be collectively applied to the haptic experience service providing process.

Namely, in the haptic experience service system, a data structure may be classified into an apparatus definition data package including variables for defining the type and feature of the haptic reproduction apparatus 100, and environmental factor definition package including variables for a virtual object, an object-surface feature, and an environment of the object that are used for the haptic experience service, and an interaction value definition package including apparatus input/output data variables and haptic data calculation variables that are used to generate the haptic data output value.

Now, components of the haptic experience service system and the data package structure are described in detail.

FIG. 2 is a view illustrating a configuration of a haptic reproduction apparatus of the haptic experience service system according to the embodiment of the present invention.

As shown in FIG. 2, the haptic reproduction apparatus 100 may include a force feedback apparatus 110 and a texture expression apparatus 120.

The force feedback apparatus 110 performs a function of providing a haptic experience service associated with a virtual object and environment to a user by using a force. The force feedback apparatus 110 includes a grip for providing a haptic sense of the virtual object or environment to the user. Therefore, the user can contact the virtual object and environment through the grip.

The texture expression apparatus 120 performs a function of providing the haptic experience service associated with the virtual object and environment to the user by using a texture.

The texture expression apparatus 120 includes a pin array having a plurality of pins for directly stimulating a skin of the user. Therefore, the user can recognize the texture of the virtual object and environment through the pin array. The texture expression apparatus 120 may further include at least one of a vibration motor and a heat transfer device, so that the user can recognize a temperature and force as well as the texture of the virtual object and environment.

In the haptic experience service system, since the haptic reproduction apparatus 100 is constructed with the force feedback apparatus 110 and the texture expression apparatus 120, the haptic information of the force and the texture can be provided to the user.

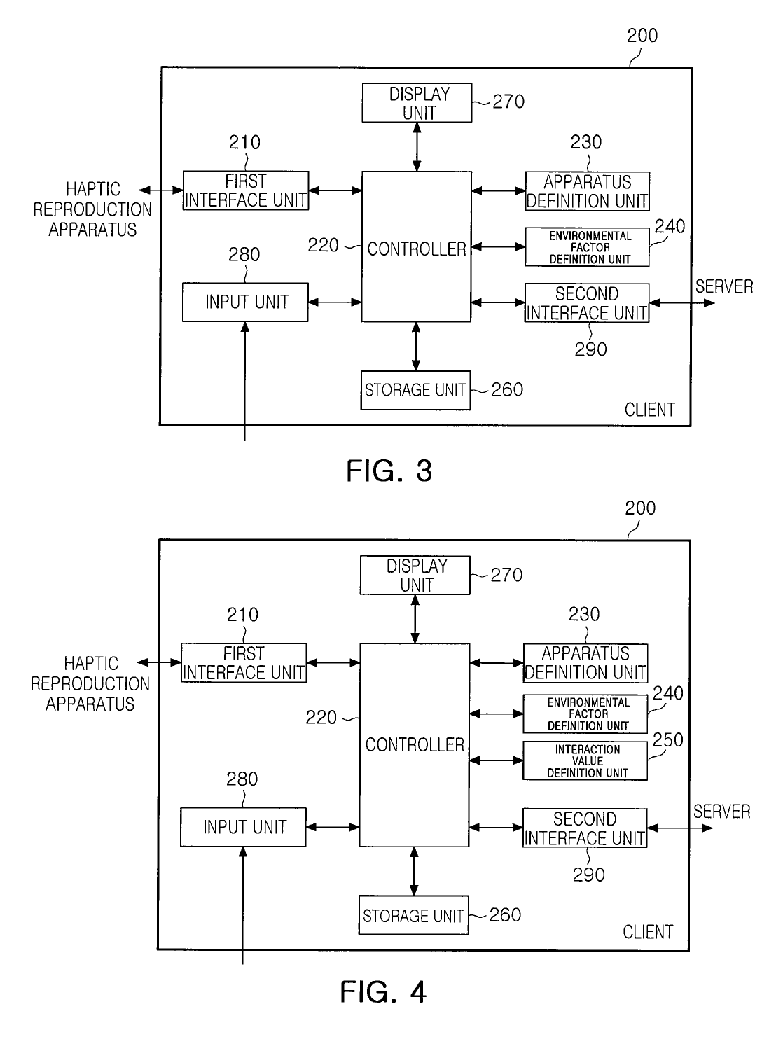

FIG. 3 is a view illustrating a configuration of a client of the haptic experience service system according to the embodiment of the present invention.

As shown in FIG. 3, the client 200 includes a first interface unit 210, a controller 220, an apparatus definition unit 230, an environmental factor definition unit 240, a storage unit 260, a display unit 270, an input unit 280, and a second interface unit 290.

The client 200 allows the first interface unit 210 to be connected to the haptic reproduction apparatus 100 via wire or wireless communication interface such as RS232, USB, IEEE 1394, WLAN, UWB, RF, and Bluetooth. The client 200 controls the apparatus definition unit 230 according to a haptic experience service request that the user inputs by using the input unit 280, so that a type and feature of the haptic reproduction apparatus 100 connected to the first interface unit 210 can be selected and inputted by the user.

The apparatus definition unit 230 includes a class and package of data of variables associated with the type and feature of the haptic reproduction apparatus 100. The variables are outputted on the display unit 270 under the control of the controller 220, so that the user can select the variables suitable for the type and feature of the haptic reproduction apparatus 100.

When the type and feature of the haptic reproduction apparatus 100 are selected and inputted by the user, the controller 220 generates an apparatus definition data package including the type and feature and stores the apparatus definition data package in the storage unit 260 and invokes an environmental factor definition unit 240 which can access the server 300. Next, the controller 220 transmits the apparatus definition data package to the server 300 through the second interface unit 290.

The controller 220 allows the user to access the server 300 by using the environmental factor definition unit 240 and the second interface unit 290, so that the user can select the virtual experience environmental factor corresponding to the user-desired haptic experience service such as the type and feature of the virtual object and environment and environmental conditions. In response to the user's selection, the controller 220 can display a visual data associated with the experience environment provided from the server 300 on the display unit 270.

Next, the controller 220 transmits the user input data provided from the haptic reproduction apparatus 100 through the first interface unit 210 to the server 300. The controller 220 receives a haptic data output value that is interacted with the input data from the server 300 and transmits the haptic data output value to the haptic reproduction apparatus 100.

Namely, the controller 220 receives from the haptic reproduction apparatus 100 the input data generated according to motion or touch which the user applies to the haptic reproduction apparatus 100 for the virtual experience environment and transmits the input data to the server 300. The controller 220 receives from the server 300 a haptic data output value used to provide to the user a haptic sense of the virtual experience environment interacted with the input data and transmits the haptic data output value to the haptic reproduction apparatus 100.

At this time, the controller 220 transforms a coordinate system and a scale of the input data received from the haptic reproduction apparatus 100 and the haptic data output value received from the server 300 by using a transformation matrix corresponding to the input data to generate values reflecting the features of the haptic reproduction apparatus 100.

FIG. 4 is a view illustrating a configuration of a client of a haptic experience service system according to another embodiment of the present invention.

As shown in FIG. 4, the client 200 may include the first interface unit 210, the controller 220, the apparatus definition unit 230, the environmental factor definition unit 240, an interaction value definition unit 250, the storage unit 260, the display unit 270, the input unit 280, and the second interface unit 290.

The client 200 allows the first interface unit 210 to be connected to the haptic reproduction apparatus 100 via RS232, USB, or the like. The client 200 controls the apparatus definition unit 230 according to a haptic experience service request that the user inputs by using the input unit 280, so that a type and feature of the haptic reproduction apparatus 100 connected to the first interface unit 210 can be selected and inputted by the user.

The apparatus definition unit 230 includes a class and package of data of variables associated with the type and feature of the haptic reproduction apparatus 100. The variables are outputted on the display unit 270 under the control of the controller 220, so that the user can select the variables suitable for the type and feature of the haptic reproduction apparatus 100.

When the type and feature of the haptic reproduction apparatus 100 are selected and inputted by the user, the controller 220 generates an apparatus definition data package including the type and feature and stores the apparatus definition data package in the storage unit 260 and invokes an environmental factor definition unit 240 which can access the server 300. Next, the controller 220 transmits the apparatus definition data package to the server 300 through the second interface unit 290.

The controller 220 allows the user to access the server 300 by using the environmental factor definition unit 240 and the second interface unit 290, so that the user can select the virtual experience environmental factor corresponding to the user-desired haptic experience service such as the type and feature of the virtual object and environment and environmental conditions. In response to the user's selection, the controller 220 generates the experience environment by using the virtual haptic experience environmental factor provided from the server 300.

The controller 220 extracts a visual data associated with the experience environment such as a shape and coordinate information of the experience environment from the environmental factor defined and provided by the server 300 and displays the visual data on the display unit 270.

When the user input data, that is, the input data generated by the user moving the haptic reproduction apparatus 100 is provided from the haptic reproduction apparatus 100 through the first interface unit 210, the controller 220 outputs the user input data to the interaction value definition unit 250, so that the interaction value definition unit 250 can generate the haptic data output value interacted with the input data.

The interaction value definition unit 250 includes a class and package of data of variables associated with the input/output data of the haptic reproduction apparatus 100 and variables associated with the haptic data calculation. The interaction value definition unit 250 calculates a correlation between a previously-calculated experience environmental data and the input data by using the variables to generate the haptic data output value.

The controller 220 transmits the haptic data output value generated from the interaction value definition unit 250 to the haptic reproduction apparatus 100, so that a haptic sense of the virtual experience environment interacted with motion or touch which the user applies to the haptic reproduction apparatus for the virtual experience environment can be provided to the user.

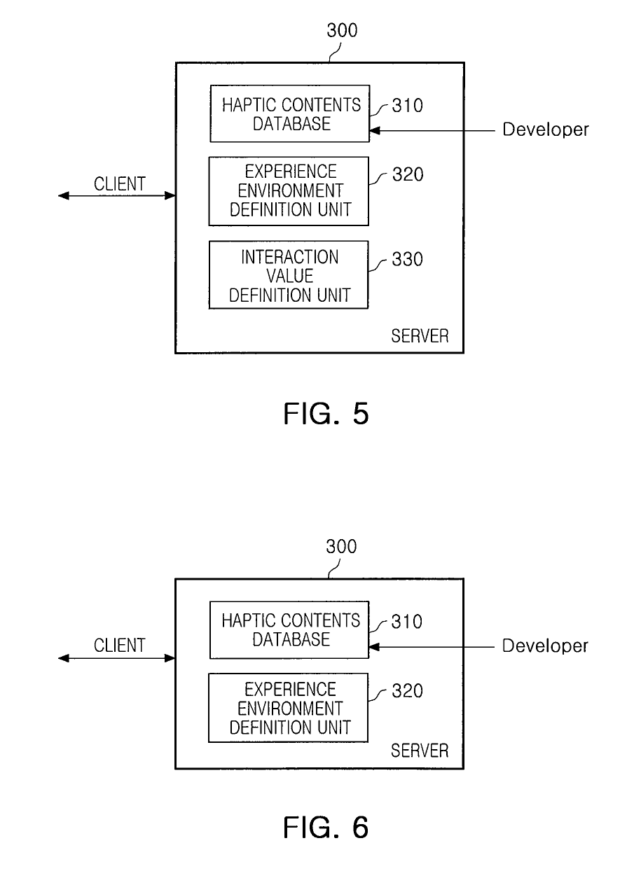

FIG. 5 is a view illustrating a configuration of a server of a haptic experience service system according to an embodiment of the present invention.

As shown in FIG. 5, the server 300 may include a haptic contents database 310, an experience environment definition unit 320, and an interaction value definition unit 330.

The haptic contents database 310 includes haptic contents which are constructed with a plurality of environmental factor variables. The haptic contents are described by a developer using a markup language such as XML or script.

When the user accessing the haptic contents database 310 through the client 200 selects the virtual experience environmental factor corresponding to the user-desired haptic experience service, the haptic contents database 310 provides the virtual experience environmental factor to the experience environment definition unit 320. The experience environment definition unit 320 defines the environmental factor according to the virtual experience environmental factor and generates the experience environment. The experience environment definition unit 320 provides a visual data associated with the experience environment to the client 200.

The interaction value definition unit 330 generates the haptic data output value interacted with the input data of the haptic reproduction apparatus 100 provided from the client 200, so that the haptic data output value can be transmitted to the haptic reproduction apparatus 100 through the client 200.

The interaction value definition unit 330 may include a class and package of data of the variables associated with the input/output data of the haptic reproduction apparatus 100 and the variables associated with the haptic data calculation.

FIG. 6 is a view illustrating a configuration of a server of a haptic experience service system according to another embodiment of the present invention.

As shown in FIG. 6, the server 300 may include a haptic contents database 310 and an experience environment definition unit 320.

The haptic contents database 310 includes haptic contents which are constructed with a plurality of environmental factor variables. The haptic contents are described by a developer using a markup language such as XML or script.

The haptic contents database 310 allows the user accessing the haptic contents database 310 through the client 200 to select the virtual experience environmental factor corresponding to the user-desired haptic experience service. The experience environment definition unit 320 defines the virtual experience environmental factor.

When the experience environment definition unit 320 defines the virtual experience environmental factor selected by the user, the experience environment definition unit 320 provides the virtual experience environmental factor to the client 200. The client 200 generates the experience environment corresponding to the virtual experience environmental factor, so that the haptic data output value interacted with the input data of the haptic reproduction apparatus 100 can be generated in the client 200.

Now, a data package structure of the haptic experience service system is described.

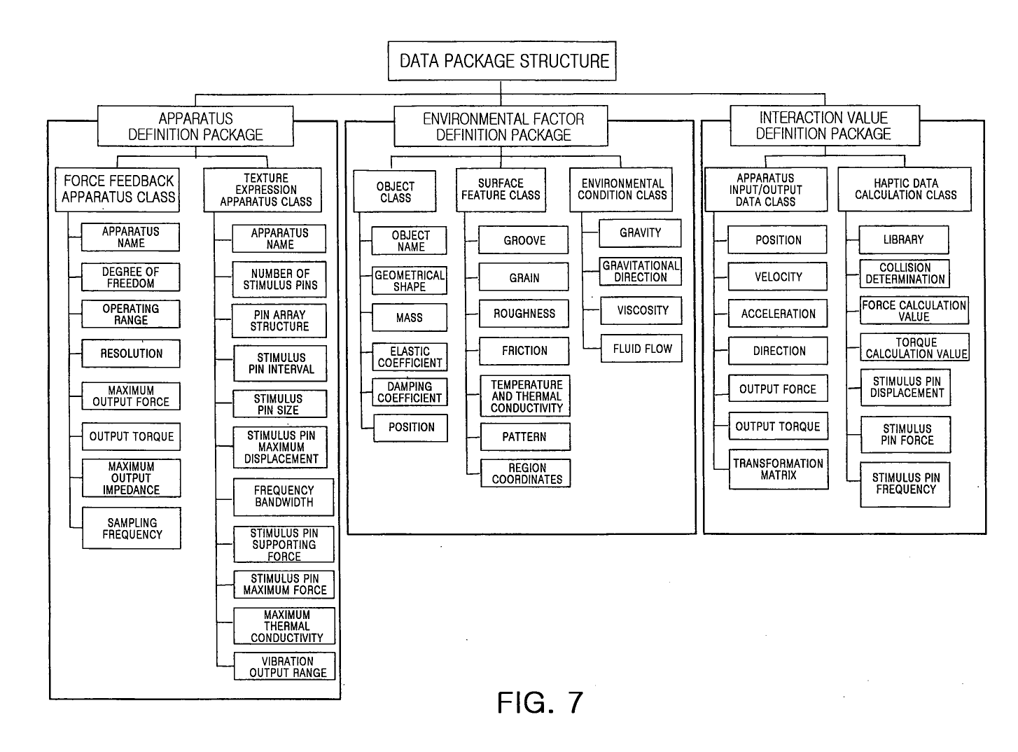

FIG. 7 is a view illustrating a data package structure of a haptic experience service system according to an embodiment of the present invention.

Referring to FIG. 7, the haptic experience service system may include data packages which are classified into an apparatus definition package, an environmental factor definition package, and an interaction value definition package so as to provide the haptic experience service through the haptic reproduction apparatus 100.

In the haptic experience service system, each of the packages is constructed with one file, one character string, a set of files, and a set of character strings. In case of a package constructed with a file or files, features of elements are represented by using a markup language or a script. In case of the package constructed with a character string or character strings, internal elements having regularity are represented to be sequentially arranged.

As shown in FIG. 5, the data package includes at least one class. Each class includes at least one variable used for providing the haptic experience service.

The apparatus definition package is a package for defining physical properties of the haptic reproduction apparatus 100. The apparatus definition package includes a force feedback class for the force feedback apparatus 110 and a texture expression apparatus class for the texture expression apparatus 120.

In the apparatus definition package, the force feedback apparatus class defines general features and performance of the force feedback apparatus 110 of haptic reproduction apparatus 100, such as an apparatus name, a degree of freedom, an operating range, a resolution, a maximum output force, an output torque, maximum output impedance, and a sampling frequency. In the apparatus definition package, the texture expression apparatus class defines general features and performance of the texture expression apparatus 120 of haptic reproduction apparatus 100, such as an apparatus name, the number of stimulus pins, a pin array structure, a stimulus pin interval, a stimulus pin size, a stimulus pin maximum displacement, a frequency bandwidth, a stimulus pin supporting force, a stimulus pin maximum force, a maximum thermal conductivity, and a vibration output range.

In the apparatus definition package, the force feedback apparatus class and the texture expression apparatus class generates apparatus features irrespective of the types of the force feedback apparatus 110 and the texture expression apparatus 120, so that the haptic features defined by the server 300 can be efficiently processed.

Namely, since the haptic contents included in the server 300 do not reflect all the features of the haptic reproduction apparatus 100, the force feedback apparatus 110 class and texture expression apparatus 120 class provide all the variables associated with the features of the haptic reproduction apparatus 100 connected to the client 200, so that the server 300 can generate the haptic data output value applied with the aforementioned variables in the generation of the haptic experience service value that is to be provided through the interaction value definition package to the haptic reproduction apparatus 100.

Accordingly, the server 300 can remove and cancel artificiality or discrepancy in the haptic experience of the virtual object or environment that the user invokes.

In the haptic experience service system, input of some elements of the force feedback apparatus class and the texture expression apparatus class may be omitted according to the features of the haptic reproduction apparatus 100. Once a class data is input, the class data is stored as a file including the name of the associated haptic reproduction apparatus 100 and transmitted to the server 300. Therefore, in a case where a user uses the apparatus having the same name again, the haptic experience service applied with the class data can be provided to the user by searching for the only the name of the apparatus.

The environmental factor definition package is defined according to a rule when the contents to be stored in the server 300 are generated.

Since the virtual environment includes objects having a shape, object-surface features, and environments of the objects, the environmental factor definition package also includes an object class, a surface feature class, and an environmental condition class.

The object class is a class for describing an object having a shape. The object class includes an object name, a geometrical shape variable, a mass variable, an elastic coefficient variable, a damping coefficient (viscosity coefficient) variable, a position variable, and the like. The surface feature class is a class for defining a surface feature of an object. The surface feature class which includes an object-surface groove depth variable, a groove size variable, a grain direction variable, a grain density variable, a roughness variable, a friction variable, a temperature variable, a thermal conductivity variable, a pattern variable, an interested region coordinates variable, and the like. The environmental condition class is a class for describing a space where an object exists. The environmental condition class includes a gravity amplitude variable, a gravitational direction variable, a flow direction variable and a viscosity variable of a fluid in a space enclosing the object.

The interaction value definition package includes an apparatus input/output data class and a haptic data calculation class.

The apparatus input/output data class defines position, velocity, acceleration, direction variables generated from the haptic reproduction apparatus 100. In addition, the apparatus input/output data class defines an output force and output torque transmitted to the force feedback apparatus 110. The defined output force and output torque are values obtained by transforming a coordinate system and scale through a transformation matrix.

The haptic data calculation class is a class for defining a haptic data calculation method, a calculation variable, and a calculation result variable. In the haptic data calculation class, a library including a generally-known method of touching a virtual object may be registered as a variable. In addition, the haptic data calculation class may include a variable for determining whether or not there is a conflict. In addition, the haptic data calculation class defines a force calculation value, a torque calculation value, a stimulus pin displacement, a stimulus pin force, a stimulus pin frequency, and the like.

The variables defined in the apparatus definition data package is used at one time when the haptic reproduction apparatus 100 is connected to the client 200. The haptic contents are generated based on the environmental factor definition package and stored in the server 300. At the time of haptic interaction, the associated date is collectively transmitted between the haptic reproduction apparatus 100 and the server 300 or between the haptic reproduction apparatus 100 and the client 200 by using the interaction value definition package, so that the user can experience the haptic information service uniformly.

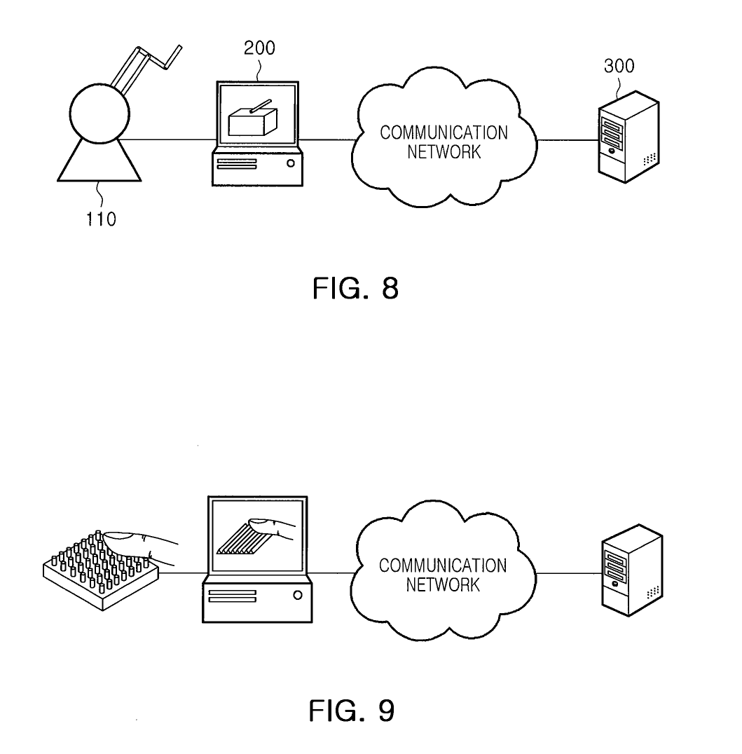

FIG. 8 is a view illustrating a configuration of the force feedback apparatus 110 of the haptic experience service system according to an embodiment of the present invention.

As shown in FIG. 8, in the haptic experience service system, the force feedback apparatus 110 of the haptic reproduction apparatus 100 includes a grip for providing a haptic sense of the virtual object or environment to the user, so that the user touching the virtual object and environment through the grip can experience a force haptic sense associated with the virtual object and environment.

In addition, in the haptic experience service system, the virtual object and environment corresponding to the user's desired haptic experience service can be displayed on the display unit 270 of the client 200.

FIG. 9 is a view illustrating a configuration of a texture reproduction apparatus of the haptic experience service system according to an embodiment of the present invention.

As shown in FIG. 9, in the haptic experience service system, the texture expression apparatus 120 of the haptic reproduction apparatus 100 includes a pin array having a plurality of pins for directly stimulating a skin of the user, so that the user can experience a texture of the virtual object and environment through the pin array.

In addition, in the haptic experience service system, the virtual object and environment corresponding to the user's desired haptic experience service can be displayed on the display unit 270 of the client 200.

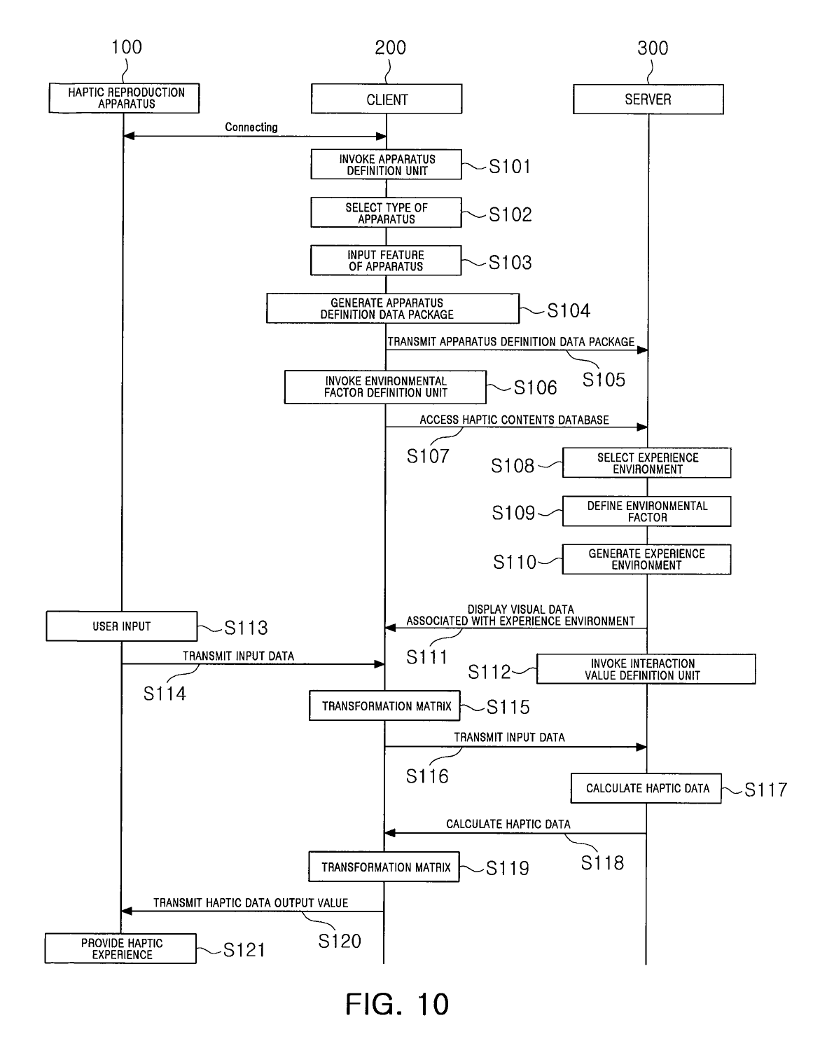

FIG. 10 is a signal flowchart illustrating a haptic experience service method according to an embodiment of the present invention.

As shown in FIG. 10, the user who desires to receive the haptic experience service in the haptic experience service system accesses the client 200 connected to the haptic reproduction apparatus 100 to invoke the apparatus definition unit of the client 200 (S101).

The user selects a type of the haptic reproduction apparatus 100 through an apparatus definition unit invoked by the client 200 (S102), and the feature thereof is input (S103).

The client 200 generates the apparatus definition data package based on the information selected and input by the user (S104), and the apparatus definition data package is transmitted to the server 300 in a format of file or character string (S105).

The user that inputs the type and feature of the haptic reproduction apparatus 100 invokes the environmental factor definition unit 240 of the client (S106). The user accesses the haptic contents database 310 of the server 300 through the client 200 (S107). The user selects a virtual experience environmental factor which the user desires to experience from the variables of the environmental factor definition package acquired from the haptic contents database 310 (S108).

The server 300 defines a to-be-serviced environmental factor according to the virtual experience environmental factor selected by the user (S109). The server 300 generates the experience environment according to the defined environmental factor (S110).

The server 300 provides a visual data associated with the generated experience environment to the client 200, so that the visual data can be displayed on the display unit 270 of the client 200 (S111). The server 300 invokes the interaction value definition unit 330 to calculate a haptic date (S112).

The user checks the visual data displayed on the client 200 and generates a user's input by moving or touching the haptic reproduction apparatus 100 (S113). The input data corresponding to the user's input is transmitted to the client 200 (S114).

When the input data is provided from the haptic reproduction apparatus 100, the client 200 transforms a coordinate system and a scale of the input data through a transformation matrix to transform the input data into the value corresponding to the feature of the haptic reproduction apparatus 100 (S115). The client 200 transmits the transformed input data to the server 300 (S116).

When the input data is provided from the client 200, the server 300 calculates the haptic data interacted with the input date by using the interaction value definition unit 330 (S117).

Namely, the server 300 calculates the haptic data of the virtual object and environment interacted with the motion of the haptic reproduction apparatus 100 exerted by the user such as a position, velocity, acceleration, a direction, or a force exerted to the haptic reproduction apparatus 100. At this time, the server 300 can calculate the haptic data by calculating a correlation between the input data and a previously-calculated experience environment data.

When the output value is generated through the haptic data calculation, the server 300 transmits the generated haptic data output value to the client 200 (S118). The client 200 transforms the haptic data output value provided by the server 300 by using a transformation matrix (S119). The client 200 transmits the transformed haptic data output value to the haptic reproduction apparatus 100 (S120).

The haptic reproduction apparatus 100 is driven according to the haptic data output value, so that the haptic experience can be provided to the user (S121).

Accordingly, the user can experience the haptic senses of the virtual object and environment interacted with the motion and force that the user exerts to the haptic reproduction apparatus 100 by using the haptic reproduction apparatus 100.

In the haptic experience service system, since the client 200 directly interacts with the server 300, high calculation performance is not necessarily required for the client 200. Therefore, the haptic experience service can be obtained through only the network transmission data processes between the server 300 and the client 200.

In addition, the haptic experience service system, since the data package is collectively processed, data processing load between the client 200 and the server 300 can be reduced. In a case where several people perform the same task in the same environment, several clients 200 access one server 300, and the server 300 transmits simultaneously-processed data to the several client 200. Therefore, a discrepancy in experience caused from a response time delay between the users can be minimized.

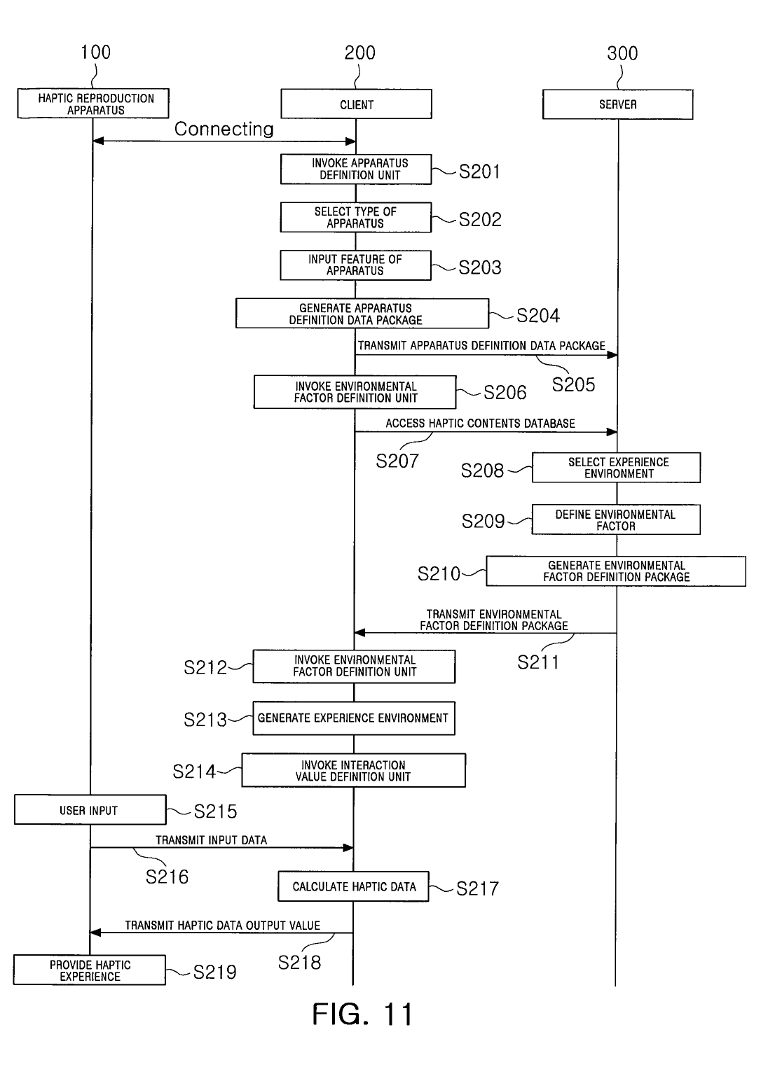

FIG. 11 is a signal flowchart illustrating a haptic experience service method according to another embodiment of the present invention.

As shown in FIG. 11, in the haptic experience service system according to another embodiment of the present invention, the user who desires to receive a haptic experience service access the client 200 connected to the haptic reproduction apparatus 100 to invoke the apparatus definition unit of the client 200 (S201).

The user selects a type of the haptic reproduction apparatus 100 corresponding to the user's desired haptic experience service through the apparatus definition unit invoked by the client 200 (S202), and the feature thereof is input (S203).

The client 200 generates the apparatus definition data package based on the information selected and input by the user (S204), and the apparatus definition data package is transmitted to the server 300 in a format of file or character string (S205).

The user that inputs the type and feature of the haptic reproduction apparatus 100 invokes the environmental factor definition unit 240 of the client (S206). The user accesses the haptic contents database 310 of the server 300 through the client 200 (S207). The user selects a virtual experience environmental factor which the user desires to experience from the variables of the environmental factor definition package acquired from the haptic contents database 310 (S208).

The server 300 defines the to-be-serviced environmental factor according to the experience environmental factor selected by the user (S209), generates an environmental factor data package (S210), and transmits the environmental factor data package to the client 200 (S211). The server 300 transmits the environmental factor data package to the client 200 in a format of a file or a character string.

When the environmental factor data package is provided from the server 300, the client 200 extracts a visual data associated with the experience environment such as a shape and coordinate information of the to-be-serviced experience environment from the environmental factor data and displays the visual data on the display unit 270 (S212).

The client 200 extracts the to-be-serviced experience environment from the environmental factor data package provided by the server 300 to generate the experience environment (213). The client 200 invokes the interaction value definition unit 250 to calculate the haptic data corresponding to the experience environment (S214).

The user checks the visual data displayed on the client 200 and generates a user's input by moving or touching the haptic reproduction apparatus 100 (S215). The input data corresponding to the user's input is transmitted to the client 200 (S216).

When the input data is provided from the haptic reproduction apparatus 100, the client 200 calculates the haptic data interacted with the input data through the interaction value definition unit 250 (S217). At this time, the client 200 calculates the haptic data by calculating a correlation between the input data and a previously-calculated experience environment data.

When the output value is generated through the haptic data calculation, the client 200 transmits the generated haptic data output value to the haptic reproduction apparatus 100 (S218). The haptic reproduction apparatus 100 is driven according to the haptic data output value, so that the haptic experience can be provided to the user (S219).

In the haptic experience service system according to another embodiment of the present invention, the haptic experience service is implemented mainly by the client 200 connected to the server 300. Therefore, the haptic experience service system can be applied to in a case where one content is experienced by several users.

In many environments for transmitting the haptic information, a rapid response to a human motion is needed, so that a rapid update is also required.

Therefore, in the present invention, in order to reduce load associated with the transmission and reception of the entire data packages, IDs may be allocated to the packages, the classes in the packages, or the types of classes, so that only the necessary variables can be transmitted and received by using the allocated package IDs, class IDs, or variable positions.

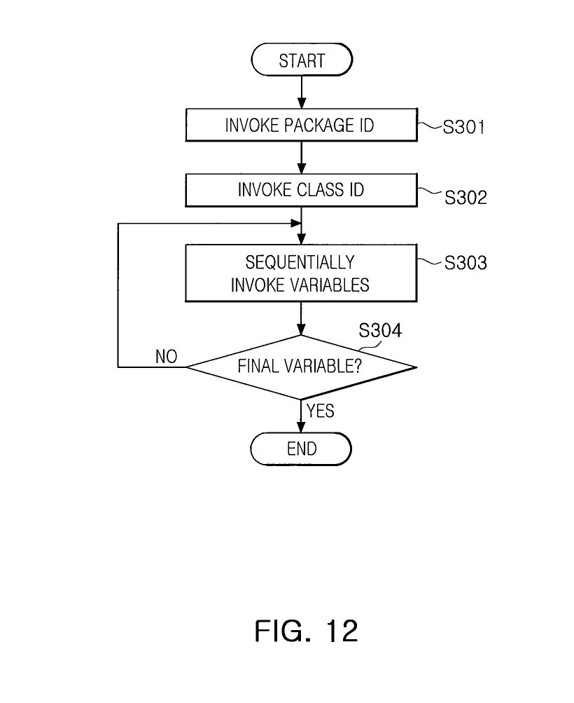

FIG. 12 is a flowchart illustrating a data package invoking method in a haptic experience service system according to an embodiment of the present invention.

As shown in FIG. 12, in the haptic experience service system, when the haptic experience service is to be performed, the data package IDs required for the performing of the service are firstly invoked (S301). Next, the class IDs required for the performing of the service is invoked from the invoked data package (S302).

Next, in the haptic experience service system, the variables are sequentially invoked from the invoked classes corresponding to the class IDs (S303). The haptic experience service is performed up to the final variable (S304).

According to the present invention, in a haptic experience service method and system, haptic information on force and texture are efficiently provided to a user, so that it is possible to improve a degree of a user's satisfaction of the haptic experience service.

In addition, according to the present invention, in the haptic experience service method and system, since all the variables used for the haptic experience service is generated, stored, and transmitted in a format of data package, the haptic experience service can be collectively provided irrespective of haptic reproduction apparatuses.

In addition, according to the present invention, in the haptic experience service method and system, a plurality of clients access one server, so that a plurality of users can be simultaneously provided with the same haptic experience environment. In addition, a plurality of users can be individually provided with different haptic experience environments. Accordingly, it is possible to effectively provide the haptic experience service based on the server.

While the present invention has been shown and described in connection with the exemplary embodiments, it will be apparent to those skilled in the art that modifications and variations can be made without departing from the spirit and scope of the invention as defined by the appended claims.

What is claimed is:

1. A haptic experience service system, comprising:
a haptic reproduction apparatus providing haptic information of a force and texture of a virtual object or environment to a user
a server defining a virtual environmental factor corresponding to a user-desired haptic experience service by using a haptic contents database constructed with an environmental factor definition package, generating an experience environment corresponding to the environmental factor, and generating a haptic data output value corresponding to an input data of the haptic reproduction apparatus in the experience environment by using an interaction value definition package and an apparatus definition variable of the haptic reproduction apparatus; and
a client recognizing an access of the haptic reproduction apparatus, providing the apparatus definition variable of the haptic reproduction apparatus to the server by using an apparatus definition data package, displaying a visual data associated with the experience environment generated by the server, transmitting to the server an input data generated by a user's manipulation and received from the haptic reproduction apparatus, receiving the haptic data output value interacted with the input data, and providing the haptic data output value to the haptic reproduction apparatus.

2. The haptic experience service system of claim 1, wherein the client comprises:
an apparatus definition unit including the apparatus definition data package to define variables of type and feature of the haptic reproduction apparatus;
an environmental factor definition unit allowing the user to select the virtual environmental factor corresponding to the user-desired haptic experience service; and
a controller providing the virtual environmental factor selected through the environmental factor definition unit to the server, displaying the visual data associated with the virtual experience environment provided from the server on a display screen, and transmitting the haptic data output value and the input data generated from the server and the haptic reproduction apparatus to the haptic reproduction apparatus and the server.

3. The haptic experience service system of claim 1, wherein the client transforms a coordinate system and a scale of the haptic data output value and the input data generated from the server and the haptic reproduction apparatus in reflection of a feature of the haptic reproduction apparatus by using a transformation matrix corresponding to the haptic data output value and the input data and transmits the transformed haptic data output value and input data to the haptic reproduction apparatus and the server.

4. The haptic experience service system of claim 1, wherein the server comprises:
a haptic contents database including the environmental factor definition package to define a virtual haptic experience environmental factor to be serviced to the user accessing the server through the client;
an experience environment definition unit defining the environmental factor selected by the user and generating the experience environment corresponding to the environmental factor; and
an interaction value definition unit including the interaction value definition package to generate the haptic data output value interacted with the input data by using the interaction value definition package when receiving the input data of the haptic reproduction apparatus requested to be applied to the experience environment.

5. The haptic experience service system of claim 1, wherein the server calculates a correlation between a previously calculated experience environment data and the input data by using the interaction value definition package to generate the haptic data output value.

6. The haptic experience service system of claim 1,
wherein each of the packages has an ID (identifier) unique to the package,
wherein each of the packages includes a plurality of classes having the same ID, and
wherein each of the classes includes a plurality of variables.

7. The haptic experience service system of claim 1,
wherein each of the packages is constructed with at least one of one file, one character string, a set of files, and a set of character strings,
wherein, in case of a package constructed with a file or files, features of elements are represented by using a markup language or a script, and
wherein, in case of a package constructed with a character string or character strings, internal elements are represented to be sequentially arranged.

8. The haptic experience service system of claim 1,
wherein the apparatus definition data package includes variables for defining a type and physical properties of an apparatus,
wherein the environmental factor definition package includes variables for a virtual object, an object-surface feature, and an environment of the object that are used for the haptic experience service,
wherein the interaction value definition package includes apparatus input/output data variables and haptic data calculation variables that are used to generate the haptic data output value.

9. The haptic experience service system of claim 8, wherein the apparatus definition data package includes:
a force feedback apparatus class including at least one of an apparatus name variable, a degree-of-freedom variable, an operating range variable, a resolution variable, a maximum output force variable, an output torque variable, a maximum output impedance variable, and a sampling frequency variable; and
a texture expression apparatus class including at least one of an apparatus name variable, a number-of-stimulus-pins variable, a pin array structure variable, a stimulus pin interval variable, a stimulus pin size variable, a stimulus pin maximum displacement variable, a frequency bandwidth variable, a stimulus pin supporting force variable, a stimulus pin maximum force variable, a maximum thermal conductivity variable, and a vibration output range variable.

10. The haptic experience service system of claim 8, wherein the environmental factor definition package includes:
an object class including at least one of a virtual object name variable, a geometrical shape variable, a mass variable, an elastic coefficient variable, a damping coefficient (viscosity coefficient) variable, and a position variable;
a surface feature class including at least one of an object-surface groove depth variable, a groove size variable, a grain direction variable, a grain density variable, a roughness variable, a friction variable, a temperature variable, a thermal conductivity variable, a pattern variable, and an interested region coordinate variable; and
an environmental condition class including a gravity amplitude variable, a gravitational direction variable, and a flow direction variable and a viscosity variable of a fluid in a space enclosing the object.

11. The haptic experience service system of claim 8, wherein the interaction value definition package includes:
an apparatus input/output data class including at least one of a position variable, a velocity variable, an acceleration variable, and a direction variable that are generated in the haptic reproduction apparatus and at least one of an output force variable and an output torque variable that are to be provided to the haptic reproduction apparatus; and
a haptic data calculation class including at least one of a haptic reproduction library variable, a collision determination variable, a force calculation value variable, a torque calculation value variable, a stimulus-pin displacement variable, a stimulus-pin force variable, and a stimulus-pin frequency variable.

12. The haptic experience service system of claim 1, wherein the haptic reproduction apparatus comprises:
a force feedback apparatus including a grip for providing a haptic sense of the virtual object or environment to the user, so that a force haptic sense associated with the virtual object and environment is provided to the user through the grip; and
a texture expression apparatus including a pin array having a plurality of pins for directly stimulating a skin of the user, so that a texture haptic sense is provided to the user through the pin array.

13. The haptic experience service system of claim 12, wherein the texture expression apparatus further comprises at least one of a vibration motor and a heat transfer device.

14. A haptic experience service system, comprising:
a haptic reproduction apparatus providing haptic information of a force and texture of a virtual object or environment to a user
a server defining a virtual environmental factor to be serviced to the user by using a haptic contents database constructed with an environmental factor definition package; and
a client recognizing an access of the haptic reproduction apparatus, generating an experience environment corresponding to the virtual environment factor, displaying a visual data associated with the experience environment, generating a haptic data output value interacted with the input data generated by a user's manipulation and received from the haptic reproduction apparatus by using an interaction value definition package, and providing the haptic data output value to the haptic reproduction apparatus.

15. The haptic experience service system of claim 14, wherein the client comprises:
an apparatus definition unit including the apparatus definition data package to select variables of type and feature of the haptic reproduction apparatus;
an environmental factor definition unit selecting the virtual environmental factor corresponding to the user-desired haptic experience service;
a controller transmitting the virtual environmental factor selected by the environmental factor definition unit to the server to generate the experience environment corresponding to the virtual environmental factor, extracting a visual data associated with the experience environment to display the visual data, and transmitting to the haptic reproduction apparatus the haptic data output value corresponding to the input data of the haptic reproduction apparatus in cooperation with the apparatus definition unit and the interaction value definition unit; and
an interaction value definition unit including the interaction value definition package to define the haptic data output value interacted with the input data provided from the haptic reproduction apparatus.

16. The haptic experience service system of claim 14, wherein the client calculates a correlation between a previously calculated experience environment data and the input data by using the interaction value definition package to generate the haptic data output value.

17. The haptic experience service system of claim 14, wherein the server comprises:
a haptic contents database including the environmental factor definition package to allow the user accessing the server through the client to select the virtual environmental factor corresponding to the user-desired haptic experience service; and
an environmental factor definition unit defining the virtual environmental factor selected by the user to provide the virtual environmental factor to the client.

18. A haptic experience service method in a haptic experience service system, comprising:
a user who desires to receive a haptic experience service selecting and inputting a type and feature of a haptic reproduction apparatus through a client connected to the haptic reproduction apparatus;
the client generating an apparatus definition data package based on the type and feature of the haptic reproduction apparatus and transmitting the apparatus definition data package to the server;
the user accessing the server through the client and selecting a virtual environmental factor corresponding to a user-desired virtual haptic experience service;
the server defining the virtual environmental factor according to the user's selection, generating a virtual experience environment corresponding to the virtual environmental factor, and providing a visual data of the virtual experience environment to the client;
the client displaying the visual data on a display screen and transmitting an input data received from the haptic reproduction apparatus to the server under the control of the user who checks the visual data; and
the server generating a haptic data output value interacted with the input data and providing the haptic data output value to the haptic reproduction apparatus through the client.

19. The haptic experience service method of claim 18, wherein, in the server generating the haptic data output value, the server calculates a correlation between a previously calculated experience environment data and the input data by using an interaction value definition package including apparatus input/output data variables and haptic data calculation variables to generate the haptic data output value.

20. The haptic experience service method of claim 18, wherein, in the client transmitting the input data to the server, the client transforms a coordinate system and a scale of the input data in reflection of the feature of the haptic reproduction apparatus by using a transformation matrix corresponding to the input data and transmits the transformed input data to the server.

21. The haptic experience service method of claim 18, wherein, in the client transmitting the haptic data output value to the haptic reproduction apparatus, the client transforms a coordinate system and a scale of the haptic data output value in reflection of the feature of the haptic reproduction apparatus by using a transformation matrix corresponding to the haptic data output value, and transmits the transformed haptic data output value to the server.

22. The haptic experience service method of claim 18, wherein, in the client transmitting the apparatus definition data package to the server, the client transmits the apparatus definition data package in a format of file or character string to the server.

23. The haptic experience service method of claim 18, wherein, in the user selecting the virtual haptic experience environmental factor, the user accesses a haptic contents database of the server including variables for a virtual object, an object-surface feature, and an environment of the object that are used for the haptic experience service and selects an environmental factor variable included in the haptic contents database.

24. A haptic experience service method in a haptic experience service system, comprising:
a user who desires to receive a haptic experience service selecting and inputting a type and feature of a haptic reproduction apparatus through a client connected to the haptic reproduction apparatus;
the client generating an apparatus definition data package based on the type and feature of the haptic reproduction apparatus and transmitting the apparatus definition data package to the server;
the user accessing the server through the client and selecting a virtual environmental factor corresponding to a user-desired virtual haptic experience service, so that the server defines an environmental factor according to the user's selection and provides the environmental factor to the client;
the client generating an experience environment corresponding to the environmental factor, extracting a visual data associated with the experience environment, and displaying the visual data on a display screen; and
the client generating a haptic data output value interacted with the input data received from the haptic reproduction apparatus under the control of the user and providing the haptic data output value to the haptic reproduction apparatus.

25. The haptic experience service method of claim 24, wherein, in the server providing the environmental factor to the client, the server generates an environmental factor data package and transmits the environmental factor data package to the client.

26. The haptic experience service method of claim 24, wherein, in the client generating the haptic data output value, the client calculates a correlation between a previously calculated experience environment data and the input data by using an interaction value definition package including apparatus input/output data variables and haptic data calculation variable to generate the haptic data output value.
